(19) United States
(12) Patent Application Publication
(10) Pub. No.: US 2026/0327470 A1
(43) Pub. Date: Oct. 22, 2026

(54) SYSTEM AND METHOD FOR RECOVERING ABRASIVE PARTICULATE

(71) Applicant: AMERMIN LLC, Austin, TX (US)

(72) Inventor: Ryan McAdams, Austin, TX (US)

(21) Appl. No.: 19/542,520

(22) Filed: Feb. 17, 2026

Related U.S. Application Data
(60) Provisional application No. 63/759,501, filed on Feb. 17, 2025.

(51) Int. Cl. C09K 3/14; C04B 35/01

(52) U.S. Cl. CPC C09K 3/1409; C04B 35/01

(57) ABSTRACT

A method for recovering abrasive particulate includes placing an article comprising a material including a metallic binder and the abrasive particulate in a basket, the basket forming a first electrode of an electrolysis device, the electrolysis device further comprising a second electrode and a power source in electrical communication between the first and second electrodes; applying a voltage potential between the first and second electrodes using the power source; whereby the metallic binder separates from the abrasive particulate. The article and basket are at least partially submerged in an electrolyte solution. The basket includes a ruthenium-iridium ceramic coating on a substrate.

### CROSS-REFERENCE TO RELATED APPLICATIONS

This application claims benefit of U.S. Provisional Application No. 63/759,501, filed Feb. 17, 2025, which is incorporated herein by reference in its entirety.

### BACKGROUND

In various drilling and cutting operations, such as those used in oil and gas extraction, mining, and construction, substantial quantities of drilling tools are used. Drilling tools commonly include drilling bits embedded with high-performance abrasives and specialty metals, such as tungsten carbide, cobalt, diamond, and other expensive materials, to enhance drilling efficiency and extend tool lifespan.

However, despite the value of these materials, the drilling tools are frequently disposed of as waste after use. The disposal of these drilling tools not only represents a financial loss due to the valuable materials contained within but also contributes to environmental concerns. The extraction, processing, and transportation of the original metals and abrasives used in the bits have considerable energy and resource costs, which are effectively wasted when the bits are not recovered and recycled.

Consequently, there is a growing demand within the industry for efficient and effective methods to recycle drilling tools derived from drilling operations. An ideal solution would enable the recovery of expensive abrasives and metals, reducing the environmental impact of these materials and allowing for their reintegration into the supply chain. Effective recycling solutions could mitigate material costs, lessen reliance on new raw materials, and support more sustainable drilling practices.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an electrolysis system.

FIG. 2 includes an illustration of an example drill.

FIG. 3 includes a block flow diagram of an example method for recovering abrasive particulate.

FIGS. 4, 5, and 6 include illustrations of example baskets.

The use of the same reference symbols in different drawings indicates similar or identical items.

### DETAILED DESCRIPTION

In an example, a method for recovering abrasive particulate includes placing an article in a basket of an electrolysis system. The article includes an abrasive material formed of a metallic binder and abrasive particulate. The article is at least partially submerged in an electrolysis solution. The basket forms an electrode of the electrolysis system. The basket includes a ruthenium-iridium coating on a substrate. The method further includes applying a voltage difference between the electrodes of the electrolysis system whereby the abrasive particulate is separated from the article.

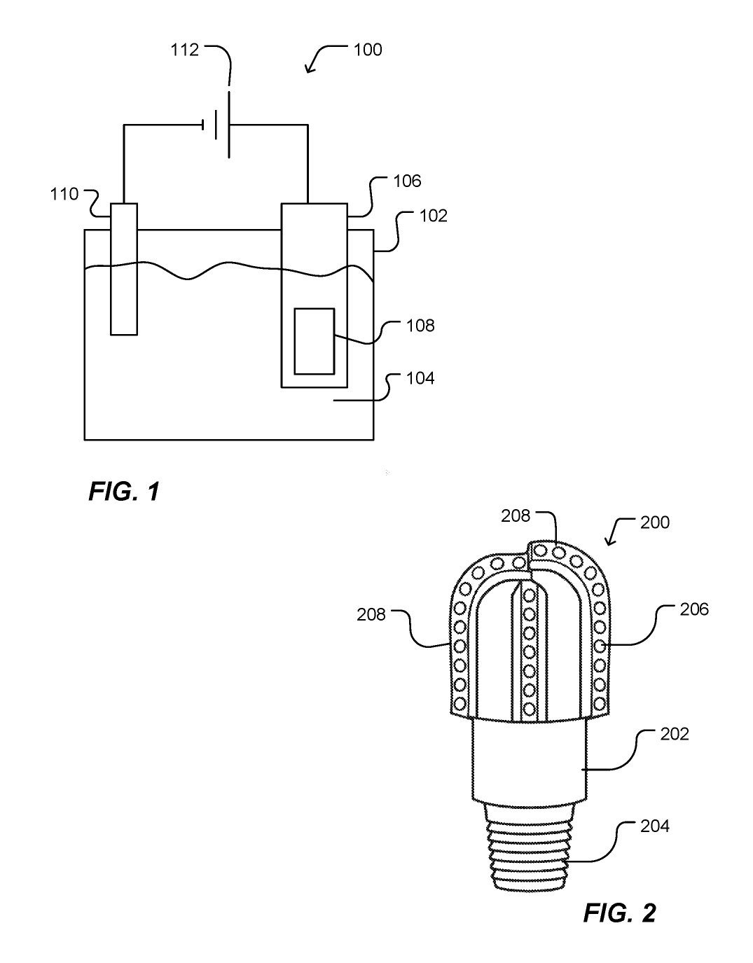

As illustrated in FIG. 1, an electrolysis system 100 includes a container 102 including an electrolysis solution 104. A basket 106 forms an electrode of the electrolysis system 100. The basket 106 is connected to a power source 112 which is connected to a second electrode 110. An article 108 can be placed in the basket 106 and at least partially submerged in the electrolysis solution 104.

The electrolysis solution 104 can be an acidic solution. In an example, the acidic solution can include hydrochloric acid, sulfuric acid, nitric acid, or a combination thereof. For example, the acidic solution can include hydrochloric acid. For example, the acidic solution can range from 0.001 M to 6 M hydrochloric acid, such as 0.001 M to 0.5 M, 0.5 M to 3 M, or 3 M to 6 M hydrochloric acid. In another example, the acidic solution can include sulfuric acid. For example, the acidic solution can range from 0.001 M to 3 M sulfuric acid, such as 0.001 M to 0.5 M, 0.5 M to 1.5 M, or 1.5 M to 3 M sulfuric acid. In an example, the acidic solution can have a pH in a range of 0 to 4, such as a range of 0 to 3, a range of 0.3 to 2, or a range of 1 to 2.

The power source 112 can provide a voltage difference, such as a DC voltage difference between the anode and the cathode. The voltage difference can be in a range of 20 V to 1000 V. For example, the voltage difference can be in a range of 100 V to 650 V, such as a range of 100 V to 500 V, or a range of 150 V to 350 V. The power supplied by the power source 112 can be a range of 10 kW to 100 kW, such as a range of 35 kW to 85 kW or a range of 45 kW to 75 kW. In some embodiments, the cell operates at a current density of about 200 to about 2,000 A/m² (about 2 to about 20 A/dm²), such as about 200 to about 1,000 A/m².

In an example, the basket 106 forms an anode and the electrode 110 forms a cathode. The basket can be a wire mesh basket. In another example, the basket can be formed of a perforated sheet material. The basket 106 can include a substrate coated with a ruthenium-iridium ceramic. For example, the ruthenium-iridium ceramic can include ruthenium iridium oxide. In a further example, the ruthenium-iridium ceramic is doped with a doping agent selected from tin, iron, bismuth, nickel, cobalt, or combinations thereof. In an alternative example, the anode can be in the form of a plate, sheet, rod, tube, wire, mesh, or any combination thereof .

In an example, the ruthenium-iridium ceramic includes ruthenium and iridium in an atomic ratio in a range of 4:1 to 1:3. For example, the atomic ratio can be in a range of 3:1 to 1:2, such as a range of 2:1 to 2:3. In a further example, the ruthenium-iridium ceramic can include ruthenium oxide in a range of 15% to 80% by weight, such as a range of 15% to 50% by weight. In another example, the ruthenium-iridium ceramic can include iridium oxide in a range of 35% percent to 85% by weight. For example, the ruthenium-iridium ceramic can include iridium oxide in a range of 45% to 80%, such as a range of 65% to 80% by weight. A doping agent can be included in an amount not greater than 5%, such as not greater than 2% by weight.

In an example, the ruthenium-iridium ceramic can have a thickness in a range of 100 nm to 110 micrometers, such as 1 micrometer to 50 micrometers, or 2 micrometers to 20 micrometers. The coating can be formed by solution coating and thermal decomposition, sol-gel coating a thermal decomposition, spin coating, electrostatic spraying, or equivalent methods.

In an example, the electrode 110 can be formed of graphite or carbon, titanium, stainless steel, or nickel or a nickel alloy, such as a Reney-Ni type cathode. In a further example, the electrode 110 can be formed of copper, brass, carbon steel, or lead. The electrode 110 can have the form of a plate, rod, felt, sheet, mesh, or an equivalent.

The electrode 110 can be disposed 2 to 20 inches from the basket 106. For example, the electrode can be 4 to 18 inches, 4 to 16 inches, or 6 to 12 inches from the basket 106.

While FIG. 1 illustrates a system 100 that includes a single electrode 110, alternatively, the system can include multiple electrodes 110. For example, the basket 106 can be placed in the middle of the container and a set of electrodes 110 can be disposed around the basket 106. In another example, a set of baskets 106 can be distributed within the system and a set of electrodes 110 disposed between baskets 106.

The system can be used to recover abrasive particles from a variety of types of articles. For example, the system can recover abrasive particles from mining tools, construction tools, or drilling tools. FIG. 2 includes an illustration of an example drill bit 200. The drill bit 200 includes a body 202 having a connection, such as a threaded connection 204 and a head 206. Abrasive inserts 208 are disposed on the head 206. The abrasive inserts 208 include a metallic binder and abrasive particulate.

The metallic binder can include nickel. In addition, the metallic binder can include cobalt, copper, molybdenum, boron, iron, chromium, silicon, zinc, carbon, or a combination thereof. For example, the metallic binder includes nickel, chromium, and silicon. In an example, the metallic binder includes nickel, chromium, silicon, and optionally other components. The metallic binder can include, for example, boron in an amount of 0.0% to 5.0%, such as 1.0% to 3.0% by weight. In another example, the metallic binder can include iron in an amount of 0.0% to 4.0%, such as 2.0% to 3.2%. In a further example, the metallic binder can include chromium in a range of 5.0% to 15.0%, such as 6.0% to 12.0%. In an additional example, the metallic binder can include silicon in an amount of 0.0% to 5.0%, such as 2.0% to 4.0%. In another example, the metallic binder can include carbon in an amount of 0.0% to 1.0%, such as 0.1% to 0.5%.

The abrasive particulate can include tungsten metal, tungsten carbide, diamond, silicon carbide, or combinations thereof. In an example, the abrasive particulate includes tungsten carbide. In another example, the abrasive particulate includes diamond. The abrasive particulate can have an average size in a range of 40 µm to 500 µm, such as a range of 40 µm to 300 µm. For example, the tungsten carbide particulate can have an average size range in a range of 40 µm to 250 µm, such as a range of 40 µm to 220 µm. The tungsten carbide powder can be a spherical cast powder. In another example, the tungsten carbide powder can be an angular cast powder. In a further example, the tungsten carbide powder is a blend of spherical cast powder and angular cast powder. The diamond particulate can have an average size in the range of 25 µm to 425 µm, such as an average size in a range of 149 µm to 297 µm pr a range of 175 µm to 255 µm.

In an example, at least the abrasive inserts 208 of the drill bit 200 can be submerged in an electrolysis solution in a basket forming electrode of an electrolysis system. The voltage difference can be applied between the basket and another electrode resulting in the dissolution of the metallic binder and release of the abrasive particulate. The abrasive particulate can be recovered and washed. Other items that can be submerged include drills, endmills, inserts, turnings, and other abrasive materials.

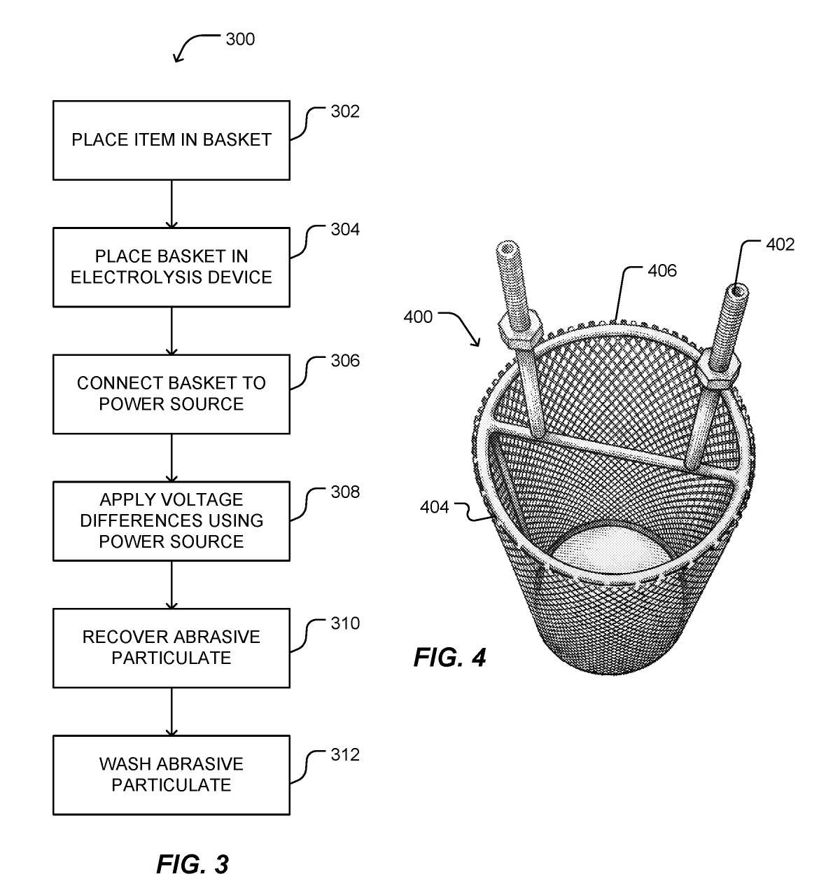

FIG. 3 illustrates an example method 300 for recovering an abrasive particulate. The method can include placing an article in a basket, as illustrated at block 302. The article can include an abrasive material formed of a metallic binder and abrasive particulate. The metallic binder can include nickel. In addition, the metallic binder can include boron, iron, chromium, silicon, zinc, carbon, or a combination thereof. The abrasive particulate can include tungsten carbide, diamond, cubic zirconium, or combinations thereof.

As illustrated at block 304, the basket can be coupled to an electrolysis system and can be connected to a power source, as illustrated at block 306. The basket and the article are at least partially submerged in an electrolysis solution.

As illustrated at block 308, a voltage difference can be applied between the basket and a second electrode. The voltage difference can be in a range of 20 V to 1000 V. For example, the voltage difference can be in a range of 100 V to 650 V, such as a range of 100 V to 500 V, or a range of 150 V to 350 V. The power supplied by the power source can be a range of 10 kW to 100 kW, such as a range of 35 kW to 85 kW or a range of 45 kW to 75 kW. In an example, the voltage difference is a constant voltage difference. In another example, the voltage difference can be a pulsed voltage difference. The voltage difference can be applied for a period of time in a range of 4 hours to 180 hours. For example, the voltage difference can be applied for a period of 8 hours to 120 hours, such as a range of 12 hours to 72 hours. The process can be controlled by monitoring current, visual inspection, solution conductivity, or related methods.

The abrasive particulate, separated from the metallic binder, can be recovered, as illustrated at block 310. For example, the abrasive particles can settle to the bottom or the basket or to the bottom a container in which the system is disposed. The recovered abrasive particulate can be washed, as illustrated at block 312. For example, the abrasive particulate can be mechanically separated or washed in a caustic solution, an acidic solution, or a solvent. The abrasive particles can optionally be filtered and sized.

FIG. 4 includes an illustration of an example basket 400, which includes connectors 402 to be connected to a power source. In the example basket 400, the structure of the basket is formed by a wire mesh 406. The basket can include a coating on a substrate. The substrate can be a metallic substrate, such as a steel, titanium, tantalum, or niobium substrate. For example, the substrate is titanium. In an example, the coating is a ruthenium-iridium ceramic.

The wire mesh basket 400 includes a wire mesh material 404 the defines openings 406. The openings can have a characteristic diameter defined as four times the opening area of the opening 406 divided by the circumference of the opening. The average characteristic diameter can be in a range of 0.1 cm to 5 cm. For example, the characteristic diameter can be in a range of 0.2 cm to 2 cm, such as a range of 0.2 cm to 1 cm.

The basket 400 can include an opening of the basket of sufficient dimensions to receive an article to be treated. For example, the opening of the basket can have an effective diameter of 10 cm to 80 cm, such as 10 cm to 60 cm or 15 cm to 60 cm.

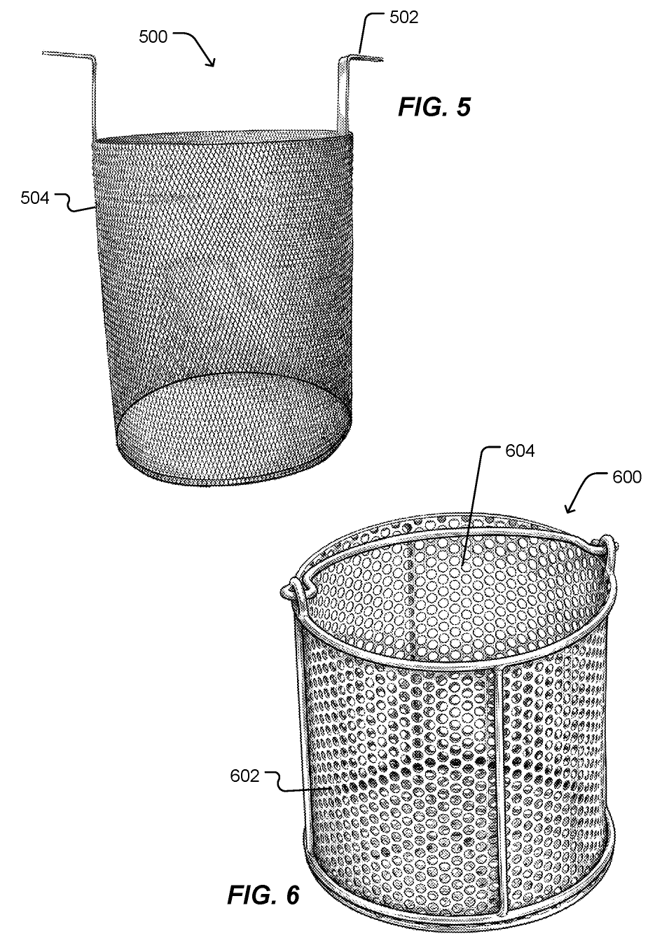

FIG. 5 illustrates another example basket 500 that includes connectors 502 to be connected with the power source and a mesh material 504 defining the structure of the basket. The mesh material can form openings having a characteristic diameter as described above.

FIG. 6 includes an example perforated sheet basket 600. For example, the structure of the basket is formed of a sheet material 602 including perforations 604. The perforations have an average characteristic diameter in a range of 0.1 cm to 5 cm. For example, the average characteristic diameter can be in a range of 0.2 cm to 2 cm, such as a range of 0.2 cm to 1 cm.

### Example 1

A drill bit is placed in a basket, and the head of the drill bit is submerged in a 0.001 M to 6M hydrochloric acid solution in a container of an electrolysis system. The basket is connected to the positive pole of a power source of the electrolysis system. The negative pole of the power source is connected to a second electrode partially submerged in the acid solution. The head of the drill bit includes portions formed of an abrasive material including a nickel alloy binder and tungsten carbide abrasive particulate. The basket is formed of a titanium wire mesh coated with a ruthenium-iridium oxide.

A voltage difference of 250V is applied between the anode and cathode for a period of 24 hours. A sludge is recovered from a container of the electrolysis apparatus. The sludge is washed and separated to provide a tungsten carbide powder.

As used herein, compositions expressed in percentages are weight percentages. Average size refers to the median size of the population of particles.

In an aspect of the invention, a method for recovering abrasive particulate is provided. The method comprises placing an article, which includes a material having a metallic binder and the abrasive particulate, in a basket. This basket forms a first electrode of an electrolysis device. The electrolysis device further includes a second electrode and a power source in electrical communication between the first and second electrodes. The article and the basket are at least partially submerged in an electrolyte solution. The basket includes a ruthenium-iridium ceramic coating on a substrate. The method further includes applying a voltage potential between the first and second electrodes using the power source, whereby the metallic binder separates from the abrasive particulate.

In another example of the aspect and the above examples, the electrolyte solution is an acid solution. In further examples, the acid solution may include hydrochloric acid or a sulfuric acid solution.

In another example of the aspect and the above examples, the metallic binder includes nickel. The metallic binder may further include components selected from the group consisting of cobalt, copper, molybdenum, boron, iron, chromium, silicon, zinc, carbon, or a combination thereof. In an example, the metallic binder includes nickel, chromium, and silicon.

In another example of the aspect and the above examples, the abrasive particulate recovered by the method may include tungsten carbide, diamonds, or silicon carbide.

In another example of the aspect and the above examples, the substrate of the basket is titanium. The ruthenium-iridium ceramic coating may specifically include Ru-Ir oxide. In some embodiments, the Ru-Ir oxide further includes a doping agent selected from Sn, Fe, Ni, Co, Bi, or combinations thereof. This doping agent may comprise not greater than 5% by weight of the Ru-Ir ceramic.

In another example of the aspect and the above examples, the atomic ratio of ruthenium to iridium in the ceramic coating is in a range of 4:1 to 1:3. More specifically, the atomic ratio may be in a range of 3:1 to 1:2, or even more specifically, in a range of 2:1 to 2:3. Furthermore, the Ru-Ir oxide may include 15% to 80% ruthenium oxides by weight, and in certain embodiments, 15% to 50% ruthenium oxide by weight.

In another example of the aspect and the above examples, the basket is configured as a wire mesh basket or a perforated metal sheet basket. The basket defines openings having a characteristic diameter in a range of 0.1 cm to 5 cm. In more specific embodiments, the characteristic diameter of these openings is in a range of 0.2 cm to 2 cm.

Note that not all of the activities described above in the general description or the examples are required, that a portion of a specific activity may not be required, and that one or more further activities may be performed in addition to those described. Still further, the order in which activities are listed is not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A method for recovering abrasive particulate, the method comprising:
placing an article comprising a material including a metallic binder and the abrasive particulate in a basket, the basket forming a first electrode of an electrolysis device, the electrolysis device further comprising a second electrode and a power source in electrical communication between the first and second electrodes, the article and basket at least partially submerged in an electrolyte solution, the basket including a ruthenium-iridium ceramic coating on a substrate; and
applying a voltage potential between the first and second electrodes using the power source;
whereby the metallic binder separates from the abrasive particulate.

2. The method of claim 1, wherein the electrolyte solution is an acid solution.

3. The method of claim 2, wherein the acid solution includes hydrochloric acid.

4. The method of claim 2, wherein the acid solution includes a sulfuric acid solution.

5. The method of claim 1, wherein the metallic binder includes nickel.

6. The method of claim 5, wherein the metallic binder further includes components selected from the group consisting of cobalt, copper, molybdenum, boron, iron, chromium, silicon, zinc, carbon or a combination thereof.

7. The method of claim 5, wherein the metallic binder includes nickel, chromium, and silicon.

8. The method of claim 1, wherein the abrasive particulate includes tungsten carbide.

9. The method of claim 1, wherein the abrasive particulate includes diamonds.

10. The method of claim 1, wherein the abrasive particulate includes silicon carbide.

11. The method of claim 1, wherein the substrate is titanium.

12. The method of claim 1, wherein the ruthenium-iridium ceramic includes Ru-IR oxide.

13. The method of claim 12, wherein the Ru-IR oxide further includes a doping agent selected from Sn, Fe, Ni, Co, Bi, or combinations thereof.

14. The method of claim 13, wherein the doping agent comprises not greater than 5% by weight of the Ru-Ir ceramic.

15. The method of claim 12, wherein an atomic ratio of ruthenium to iridium is in a range of 4:1 to 1:3.

16. The method of claim 15, wherein the atomic ratio is in a range of 3:1 to 1:2.

17. The method of claim 12, wherein the Ru-Ir Oxide includes 15% to 80% ruthenium oxides by weight.

18. The method of claim 1, wherein the basket is a wire mesh basket.

19. The method of claim 1, wherein the basket is a perforated metal sheet basket.

20. The method of claim 1, wherein the basket defines openings having a characteristic diameter in a range of 0.1 cm to 5 cm.
